(19) United States
(12) Patent Application Publication
(10) Pub. No.: US 2008/0056271 A1
(43) Pub. Date: Mar. 6, 2008

(54) SYSTEM FOR AND METHOD OF STREAMLINING COMMUNICATIONS TO MEDIA STATIONS

(76) Inventors: Charles Hengel, Woodland, MN (US); Jeff Seltzer, Edina, MN (US); Jonathan Hansen, Rogers, MN (US); Andy Gass, Maple Grove, MN (US); Scott Grand, Maple Grove, MN (US)

Correspondence Address: SCHWEGMAN, LUNDBERG & WOESSNER, P.A., P.O. BOX 2938, MINNEAPOLIS, MN, 55402, US

(21) Appl. No.: 11/469,737

(22) Filed: Sep. 1, 2006

(51) Int. Cl. H04L 12/56

(52) U.S. Cl. 370/395.4

(57) ABSTRACT

This document describes, among other things, systems and methods for streamlining communications to media stations. A method comprises an agent of a radio station group ownership entity using a website to access one or more of advertising data, scheduling data, or rewards data corresponding to at least some radio stations in the radio station group, wherein the at least some radio stations receive services from a service entity; displaying on the website to the radio station agent a simulated radio dial with an indication of which radio stations in the group of radio stations are receiving services from the service entity, and which radio stations in the group are not receiving services from the service entity; and providing on the web site to the agent an aggregate view of the advertising data, scheduling data, or rewards data for the stations receiving services from the service entity.

### TECHNICAL FIELD

This patent document pertains generally to networked communication systems, and more particularly, but not by way of limitation, to a system for, and a method of, streamlining communications to media stations by providing a single networked platform to distribute relevant information based on log-in identity.

### BACKGROUND

Media stations include entities that broadcast programs and advertisements, such as radio and television stations. Management of a media station involves tasks, such as evaluating advertising, scheduling programming, generating reports, accounting, and maintaining billing information. Typically, management tasks include communication between the media station and external agencies, such as advertising agencies, accounting firms, or production houses. Management may also involve various personnel with differing responsibilities.

### BRIEF DESCRIPTION OF THE DRAWINGS

FIG. 1 illustrates a functional block diagram of a media communications system in accordance with an example embodiment.

FIG. 2 illustrates a flow diagram of a method of communicating to media stations by use of a media communications system in accordance with an example embodiment.

FIG. 3 illustrates a flow diagram of a method of communicating to media stations by use of a media communications system in accordance with an example embodiment.

FIG. 4 illustrates a login screen in accordance with an example embodiment.

FIG. 5 illustrates a display of a list of links in accordance with an example embodiment.

FIG. 6 illustrates an advertisement list in accordance with an example embodiment.

FIG. 7 illustrates an advertisement interface that displays an advertisement contained in an advertisement file in accordance with an example embodiment.

FIG. 8 illustrates a schedule interface that displays the contents of a schedule file in accordance with an example embodiment.

FIG. 9 illustrates a rewards interface that displays the contents of a rewards file in accordance with an example embodiment.

### DETAILED DESCRIPTION

In the following detailed description of example embodiments of the invention, reference is made to specific example embodiments of the invention by way of drawings and illustrations. These examples are described in sufficient detail to enable those skilled in the art to practice the invention, and serve to illustrate how the invention may be applied to various purposes or embodiments. Other embodiments of the invention exist and are within the scope of the invention, and logical, mechanical, electrical, and other changes may be made without departing from the subject or scope of the present invention. Features or limitations of various embodiments of the invention described herein, however essential to the example embodiments in which they are incorporated, do not limit other embodiments of the invention or the invention as a whole, and any reference to the invention, its elements, operation, and application do not limit the invention as a whole but serve only to define these example embodiments. The following detailed description does not, therefore, limit the scope of the invention, which is defined only by the appended claims.

Typically, media station management is organized into several levels. For example, individual media stations may be owned by a single parent company. In an embodiment, the parent company may have a manager responsible for the management of all the individual media stations that the parent company owns. In another embodiment, a group of commonly-owned or affiliated media stations may be described as a “cluster,” with a “cluster manager” responsible for management of the cluster. Cluster management may include, for example, communication between an advertising agency and media stations within the cluster. At a different level of organization, individual media stations may have several levels of management, in some embodiments. For example, a media station manager may be responsible for all advertising and scheduling within an individual media station. In another example, advertising and scheduling may be performed by subordinate employees while the media station manager handles billing or other administrative tasks. Thus, media station managers and other employees may have different needs and responsibilities defined by their roles in the organization.

The present invention includes a system for and method of streamlining communications to media station. In particular, a media communications system provides a platform by which relevant information is distributed based on log-in identity.

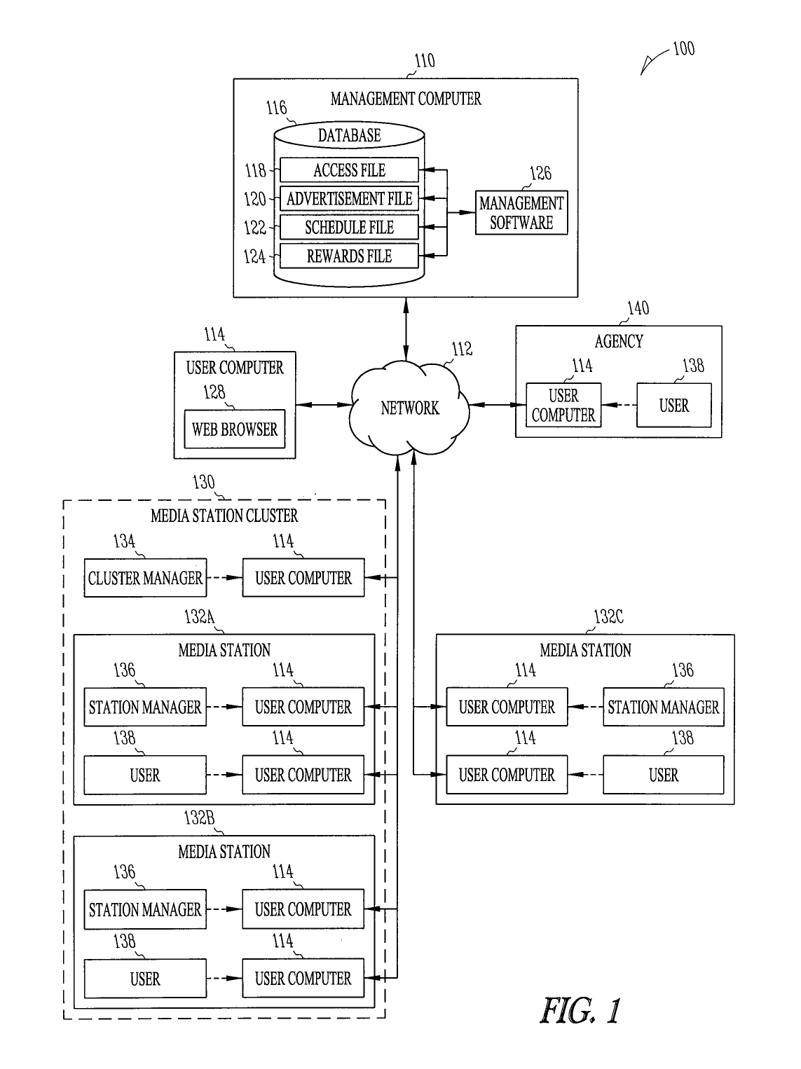

FIG. 1 illustrates a functional block diagram of a media communications system 100 in accordance with an example embodiment. In an embodiment, media communications system 100 includes a management computer 110, a network 112, and a user computer 114, which further includes a web browser 128. Management computer 110 further includes database 116 and management software 126. Database 116 further includes an access file 118, an advertisement file 120, a schedule file 122, and a rewards file 124.

In embodiments, management computer 110 includes a networked computer server used to store and distribute information relevant to media stations. Management computer 110 may contain components including databases, such as database 116, and software, such as management software 126.

Network 112 includes a communications or data network, such as a local area network (LAN), wide area network (WAN), or the Internet. In some embodiments, network 112 includes one or more wired or wireless networks.

User computer 114 includes laptops, desktops, or networked computers. User computer 114 may be used to access management computer 110 via network 112. Web browser 128 of user computer 114 is a graphical user interface (GUI) based hypertext client application, such as Internet Explorer, Mosaic, and Netscape Navigator. Web browser 128 allows the user thereof to navigate, for example, web pages on the Internet. In various embodiments, user computer 114 is used by, for example, a cluster manager (not shown), a media station manager (not shown), or other authorized user (not shown).

In an embodiment, database 116 includes a commercial database system, such as those available from Oracle Corporation (Redwood Shores, Calif.), Microsoft Corporation (Redmond, Wash.), or IBM Corporation (Armonk, N.Y.). Database 116 may be a relational database and contain a collection of related data. Database 116 includes one or more files (e.g., tables), such as access file 118, advertisement file 120, schedule file 122, and rewards file 124. Access file 118 includes, for example, data describing users, user permissions, user roles, user organizations, and other information used to control access to information in media communications system 100. Advertisement file 120 includes, for example, advertisement data, such as who reviewed, broadcasted, or accessed the advertisement, the cost of an advertisement, a copy of the advertisement or a link to the advertisement's location, and the like. Schedule file 122 includes, for example, information related to a schedule of advertisement broadcasts, information related to the advertisement broadcasts, and information related to the media station that is associated with the advertisement broadcasts. Rewards file 124 includes, for example, data related to rewards programs, such as rewards points balance, amount of points earned, and the amount of points redeemed. In an embodiment, rewards are granted to a radio station based on the amount of advertising sold to an advertiser. For example, if a radio station sells $2,000 worth of broadcast time to an advertiser, the radio station may accumulate a certain number of “rewards points” using a formula, such as two points for each dollar sold. The radio station may then use the accumulated reward points to redeem for prizes or other rewards.

Management software 126 includes a software program that determines access rights of a user by cross referencing log-in information with access information from access file 118. For example, management software 126 cross-references access file 118 with a user's log-in information, then permits or denies access to all or part of advertisements file 120, schedule file 122, or rewards file 124.

In an example embodiment, during operation, a user interfaces with web browser 128 of user computer 114 to log-in and access management computer 110 via network 112. Management software 126 uses access file 118 to determine what information the user has access to. Under the control of management software 126, the appropriate advertisement files 120, schedule files 122, or rewards files 124 are provided, such as via links in web browser 128 of user computer 114.

As illustrated in FIG. 1, in an embodiment, user computer 114 may be associated with a user 138 at a media station 132, a station manager 136 at the media station 132, or a cluster manager 134 at a media station cluster 130. In additional embodiments, users 138 at an agency 140 may interface with management computer 110 via network 112 to access data. In some embodiment, an independent media station 132c may also access data. In a further embodiment, users 138 who are unassociated with media stations, media station clusters, or agencies may access the management computer 110 using user computer 114, such as administrative users or the like.

Media station cluster 130 may include, in various embodiments, two or more commonly-owned or otherwise affiliated media stations 132. In addition, in some embodiments, cluster manager 134 includes one or more persons who are responsible for management of the media stations 132 in the media station cluster 130. In an embodiment, two or more roles may overlap in responsibility or access levels, such as cluster manager 134 being a station manager 136 of one media station 132 in the media station cluster 130.

Cluster manager 134 may use user computer 114 to access data related to media stations 132 within the corresponding media station cluster 130. For example, the functions of cluster manager 134 may include reviewing advertisements, schedules, and rewards information for each media station 132 within media station cluster 130.

Station manager 136 includes one or more persons that are responsible for the management of an individual media station 132. Station manager 136 may use user computer 114 to access data related to a particular media station 132. For example, the functions of station manager 136 may include reviewing advertisements, schedules, and rewards information for an individual media station 132.

User 138 includes other personnel associated with media station 132 or agency 140. User 138 may access data relevant to media station 132 or agency 140 via user computer 114. In one example, user 138 is responsible for monitoring rewards information for a media station 132. In another example, user 138 is responsible for organizing, presenting or managing advertising.

In an example operation, a user, (e.g., cluster manager 134, station manager 136, or user 138), interfaces with web browser 128 of the associated user computer 114 in order to log-in and access database 116 of management computer 110 via network 112. Management software 126 cross-references the user log-in data with the access file 118 to determine which file (e.g., advertisement files 120, schedule files 122, reward files 124) the user is authorized to access. The appropriate advertisement files 120, schedule files 122, and/or rewards files 124 links are made accessible to the user with management software 126 via web browser 128 of user computer 114.

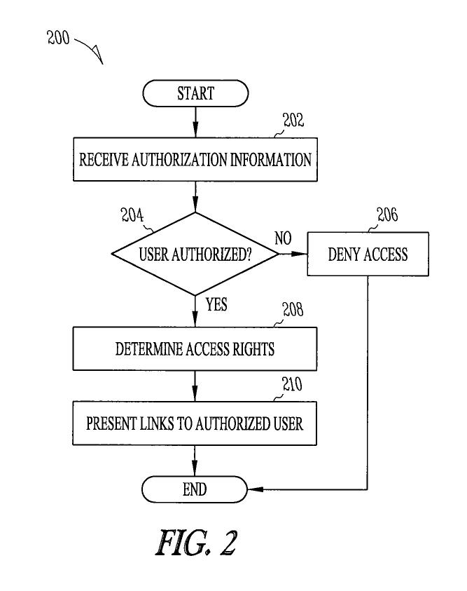

FIG. 2 illustrates a flow diagram of a method 200 of communicating to media stations by use of a media communications system 100 in accordance with an example embodiment. At 202, authorization information is received. In an embodiment, authorization information includes a username and a password. In an alternative embodiment, other authorization information is used, either in place or in conjunction with, a username and password, such as biometric information, keycards, or the like.

At 204, the authorization information is verified. If the authorization fails, then at 206, access to data is denied. On the other hand, if authorization is successful, then the method 200 proceeds to block 208.

At 208, access rights are determined. Access rights may be dependent on the user's identity, role, position, or other characteristic. For example, a cluster manager 134 may have access to more files or a different scope of information than a user 138 in a media station 132. As another example, user 138 at agency 140 may have a completely different view of data in database 116 than that of media station users (e.g., station manager 136 or cluster manager 134).

At 210, one or more links to information are presented to the user depending on the access rights determined at block 208. For example, portions or all of advertisement file 120, schedule file 122, or rewards file 124 are presented via hyperlinks to the authorized user.

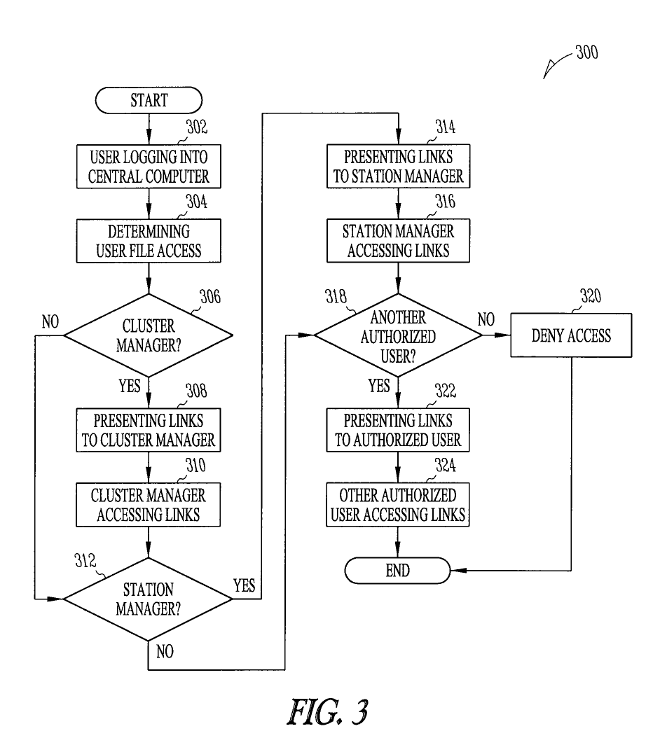

FIG. 3 illustrates a flow diagram of a method 300 of communicating to media stations by use of a media communications system 100 in accordance with an example embodiment. At 302, a user logs into management computer 110 to access database 116. For example, cluster manager 134, station manager 136, or user 138 log into management computer 110 via network 112 using web browser 128 of user computer 114.

At 304, the access level of the user is determined. In an embodiment, management software 126 determines whether the user logging in is a cluster manager 134, a station manager 136, or other authorized user 138 by cross-referencing the login ID data with access file 118 of database 116. Management software 126 may correlate a login ID from access file 118 with a corresponding cluster manager 134, station manager 136, or user 138.

At 306, whether a user is a cluster manager is determined. One or more fields or other data in access file 118 may be used to indicate whether an authorized user is a cluster manager or is associated with another role.

At 308, if the user is a cluster manager, then one or more links to authorized information is displayed, such as on web browser 128. Subsequently, at 310, the authorized cluster manager user may access the links to read or modify the information.

At 312, if the user is not a cluster manager, then whether the user is a station manager is determined. One or more fields or other data in access file 118 may be used to indicate whether an authorized user is a station manager or is associated with another role.

At 314, if the user is a station manager, then one or more links to authorized information is displayed, such as on web browser 128. In some embodiments, a cluster manager may also be a station manager. In such an embodiment, links related to one or the other roles may be displayed in separate areas of a display screen, or with different presentation (e.g., font, color, etc.) to indicate which links are related to the cluster manager role and which links are related to the station manager role. Subsequently, at 316, the authorized station manager user may access the links to read or modify the information.

At 318, if the user is not a cluster manager or a station manager, then whether the user is another authorized user is determined. One or more fields or other data in access file 118 may be used to indicate whether a user is an authorized user. At 320, if the user is not an authorized user, then access is denied.

At 322, if the user is an authorized user, such as a user associated with an agency, then one or more links to authorized information is displayed, such as on web browser 128. Subsequently, at 324, the authorized user may access the links to read or modify the information.

While method 300 depicts an example with three levels of management (e.g., cluster manager 234, station manager 236, and user 238), it is understood that there may be any number of management levels and, consequently, method 300 is not limited to three management levels.

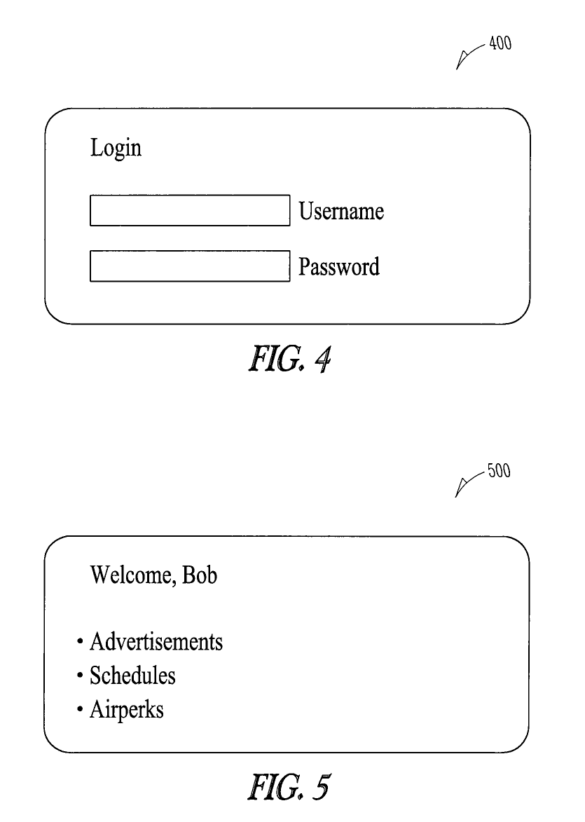

FIG. 4 illustrates a login screen 400 in accordance with an example embodiment. In an embodiment, a user 138 is presented with one or more input controls to submit authorization information to access the system 100.

FIG. 5 illustrates a display 500 of a list of links in accordance with an example embodiment. In an embodiment, after being authorized by management computer 110, based on the user's role or identity, one or more links are presented in a display, such as on a web browser 128. In the example illustrated in FIG. 5, the authorized links to database 116 are links to files related to advertisements, schedules, and rewards.

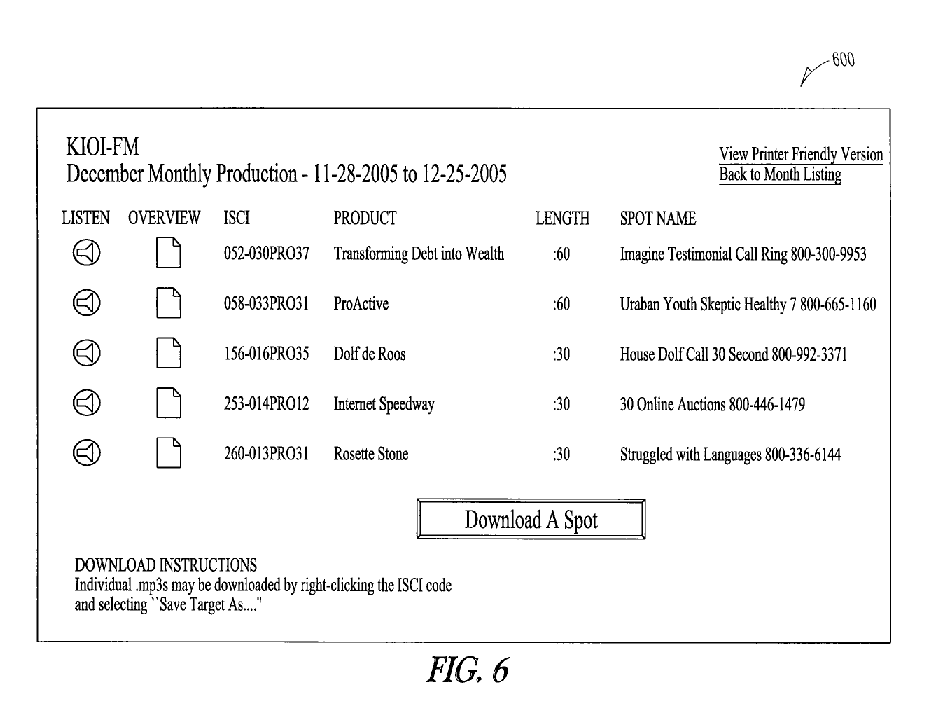

FIG. 6 illustrates an advertisement list 600 in accordance with an example embodiment. Advertisement list 600 includes one or more advertisements, which may be contained in advertisement file 120. In an embodiment, advertisement list 600 presents identifying information of the advertisements with hyperlinks to more detailed views of each advertisement. For example, the advertisement fields may include a product description, a length, and a spot name. Links may also be provided by which the user may listen to or view each advertisement.

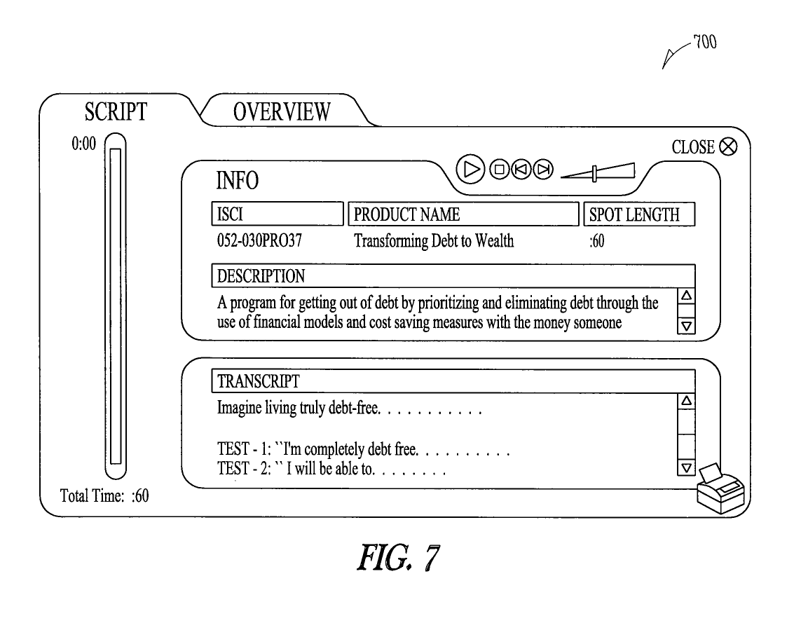

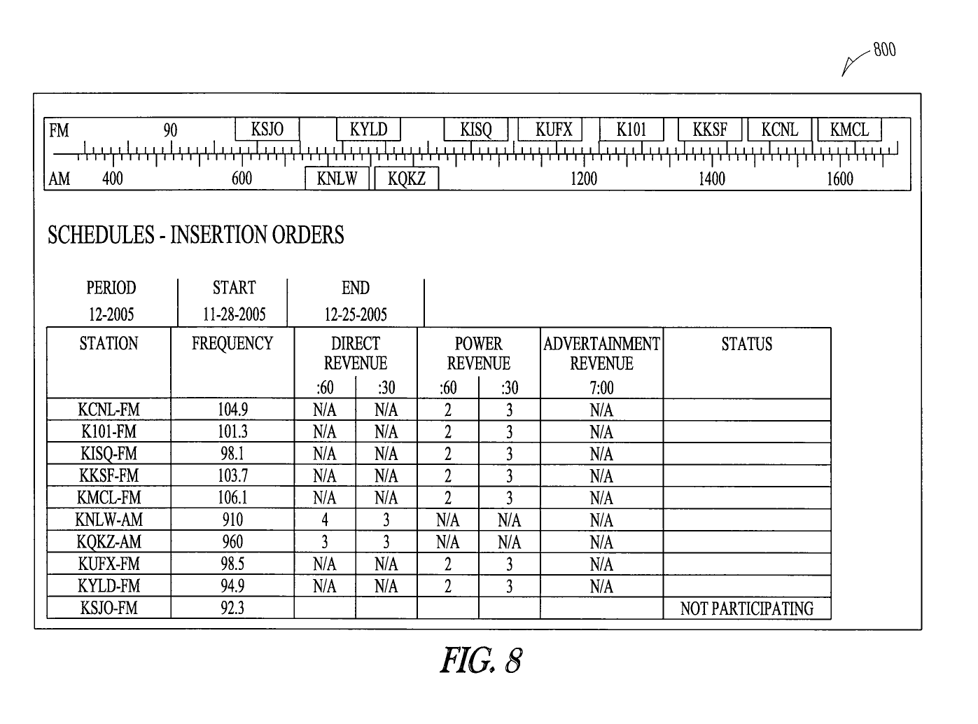

FIG. 7 illustrates an advertisement interface 700 that displays an advertisement contained in an advertisement file 120 in accordance with an example embodiment. Advertisement interface 700 may include one or more playback controls, textual description of the advertisement, or textual or audio copy. In an embodiment, authorized users may use advertisement interface 700 to add or revise comments, revise the copy, or otherwise manage the advertisement. In an embodiment, advertisement interface 700 includes annotation controls such as those described in commonly assigned patent application entitled “SYSTEM FOR AND METHOD OF VISUAL REPRESENTATION AND REVIEW OF MEDIA FILES,” Attorney Docket 2011.002US1, filed on ______.

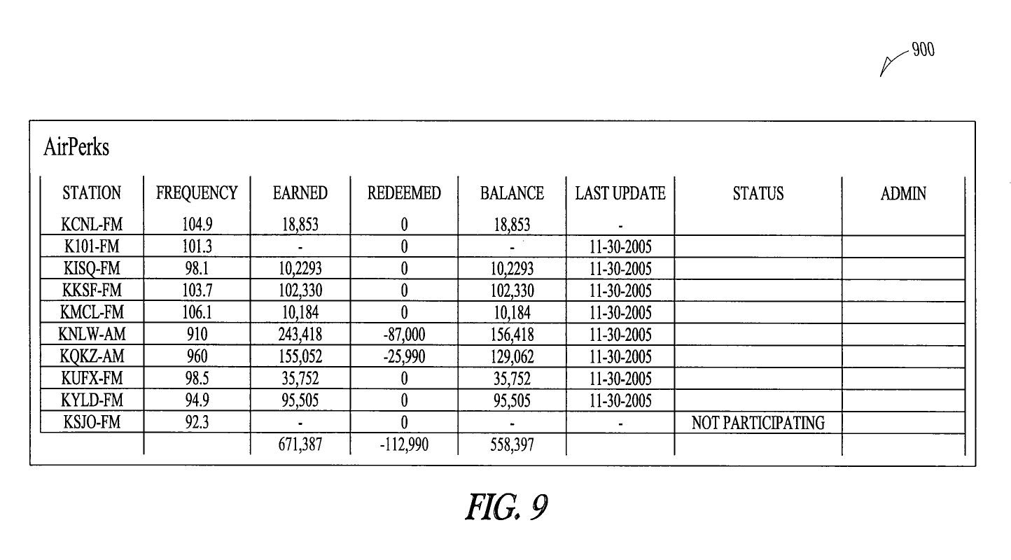

FIG. 8 illustrates a schedule interface 800 that displays the contents of a schedule file 122 in accordance with an example embodiment. In various embodiments, displayed fields include station 802, frequency 804, direct revenue 806, power revenue 808, sponsor revenue 810, “advertainment” revenue 812, and status 814. Schedule interface 800 may be used to review the volume of advertisements aired through the particular advertising agency or advertiser, such as by a radio station user or a cluster manager.

As illustrated in FIG. 8, one or more stations are indicated in the station 802 column. For each station 802, the corresponding broadcasting frequency 804 is provided. In a particular period, in this example from “11-28-2005” to “12-25-2005,” various aspects of revenue 806-812 are displayed. The status 814 field provides an indication of whether the listed station 802 is a participant. In addition, in embodiments, a graphical radio dial 816 is provided. The graphical radio dial 816 indicates in an embodiment the participating radio stations' position in the broadcasting frequency range. In another embodiment, the graphical radio dial 816 provides an indication of a state of a particular radio station. For example, radio stations that use common tools or services may be presented using the same color, font, or other visual indication. In another example, multiple colors may be used to represent a radio station's status. For example, a station may have a “gold,” “silver,” or “bronze” status based on their performance, activity, or other state. Using such a color-coded display may be advantageous, for example, to allow a cluster manager to quickly determine the state or status of radio stations in their radio station cluster.

FIG. 9 illustrates a rewards interface 900 that displays the contents of a rewards file 124 in accordance with an example embodiment. In embodiments, displayed fields include station, frequency, earned, redeemed, balance, last update, status, and administrator. In various embodiments, rewards interface 900 may be used to review rewards data received as a result of participating in airing advertisements for the particular advertising agency or advertiser.

Various embodiments may provide one or more advantages, including efficient communication between multiple organizational levels of a media organization.

It is to be understood that the above description is intended to be illustrative and not restrictive. For example, the above-described embodiments (and/or aspects thereof) may be used in combination with each other. Many other embodiments will be apparent to those of skill in the art upon reviewing the above description. The scope of the invention should, therefore, be determined with reference to the appended claims, along with the full scope of equivalents to which such claims are entitled. In the appended claims, the terms “including” and “in which” are used as the plain-English equivalents of the respective terms “comprising” and “wherein.” Also, in the following claims, the terms “including” and “comprising” are open-ended, that is, a system, device, article, or process that includes elements in addition to those listed after such a term in a claim are still deemed to fall within the scope of that claim. Moreover, in the following claims, the terms “first,” “second,” and “third,” etc. are used merely as labels, and are not intended to impose numerical requirements on their objects.

For the purposes of this specification, the term “machine-readable medium” or “computer-readable medium” shall be taken to include any medium which is capable of storing or encoding a sequence of instructions for execution by the machine and that cause the machine to perform any one of the methodologies of the inventive subject matter. The terms “machine-readable medium” or “computer-readable medium” shall accordingly be taken to include, but not be limited to, solid-state memories, optical and magnetic disks, and carrier wave signals. Further, it will be appreciated that the software could be distributed across multiple machines or storage media, which may include the machine-readable medium.

Method embodiments described herein may be computer-implemented. Some embodiments may include computer-readable media encoded with a computer program (e.g., software), which includes instructions operable to cause an electronic device to perform methods of various embodiments. A software implementation (or computer-implemented method) may include microcode, assembly language code, or a higher-level language code, which further may include computer-readable instructions for performing various methods. The code may form portions of computer program products. Further, the code may be tangibly stored on one or more volatile or non-volatile computer-readable media during execution or at other times. These computer-readable media may include, but are not limited to, hard disks, removable magnetic disks, removable optical disks (e.g., compact disks and digital video disks), magnetic cassettes, memory cards or sticks, random access memories (RAMs), read only memories (ROMs), and the like.

The foregoing description of specific embodiments reveals the general nature of the inventive subject matter sufficiently that others can, by applying current knowledge, readily modify and/or adapt it for various applications without departing from the generic concept. Therefore, such adaptations and modifications are within the meaning and range of equivalents of the disclosed embodiments. The phraseology or terminology employed herein is for the purpose of description and not of limitation. Accordingly, the inventive subject matter embraces all such alternatives, modifications, equivalents, and variations as fall within the spirit and broad scope of the appended claims.

The Abstract is provided to comply with 37 C.F.R. §1.72(b), which requires that it allow the reader to quickly ascertain the nature of the technical disclosure. It is submitted with the understanding that it will not be used to interpret or limit the scope or meaning of the claims. Also, in the above Detailed Description, various features may be grouped together to streamline the disclosure. This should not be interpreted as intending that an unclaimed disclosed feature is essential to any claim. Rather, inventive subject matter may lie in less than all features of a particular disclosed embodiment. Thus, the following claims are hereby incorporated into the Detailed Description, with each claim standing on its own as a separate embodiment.

1. A method comprising:
an agent of a radio station group ownership entity using a website to access one or more of advertising data, scheduling data, or rewards data corresponding to at least some radio stations in the radio station group, wherein the at least some radio stations receive services from a service entity;
displaying on the website to the radio station agent a simulated radio dial with an indication of which radio stations in the group of radio stations are receiving services from the service entity, and which radio stations in the group are not receiving services from the service entity; and
providing on the web site to the agent an aggregate view of the advertising data, scheduling data, or rewards data for the stations receiving services from the service entity.

2. The method according to claim 1 further including displaying an indication on the website of the preferred customer status of the group of radio stations.

3. The method according to claim 2 wherein the preferred customer status relates to rewards made available by the service entity.

4. A method comprising:
accessing one or more of advertising data, scheduling data, or rewards data from each of the radio stations in a radio station cluster, wherein the radio station cluster includes one or more commonly owned or managed radio stations; and
providing an aggregate view of the advertising data, scheduling data, or rewards data to a user authorized to access the aggregate view.

5. The method of claim 4, wherein the rewards data includes an indication of one or more unredeemed rewards of one or more radio stations, wherein the rewards are granted based on the amount of advertising or other services that the radio station provided to an advertiser.

6. A method to view radio station data, the method comprising:
providing authorization information to a central computer, wherein the authorization information indicates an access level; and
receiving access to one or more files, wherein the one or more files include an advertisement file, a scheduling file, or a rewards file; and wherein the one or more files include aggregate data if the access level corresponds to a “cluster manager access level” or filtered data if the access level corresponds to a “station manager access level.”

7. A method to view radio station data, the method comprising:
providing authorization information to a central computer, wherein the authorization information indicates an access level; and
receiving access to one or more files, wherein the one or more files include data aggregated from two or more radio stations related to advertising data, scheduling data, or rewards data.

8. A graphical user-interface, comprising:
an information presentation portion; and
a radio dial, wherein the radio dial includes a graphical representation for each of one or more radio stations in a radio station cluster, and wherein the graphical representations are arranged to correspond with a broadcasting frequency of the corresponding radio station, and wherein each graphical representation uses at least one of a color, a size, or a font to indicate a status of the radio station.

9. A method comprising:
providing authorization information to a central computer, wherein the authorization information indicates an access level; and
receiving a listing of one or more files, wherein the files provided are selected using the access level, and wherein the files include one or more of an advertisement file, a scheduling file, or a rewards file, wherein the rewards file includes an indication of one or more unredeemed rewards of a radio station, and wherein the unredeemed rewards are granted based on the amount of advertising or other services that the radio station provided to an advertiser.

10. The method of claim 9, further comprising accessing one or more of the files to retrieve one or more of an aggregate data set or a detailed data set.

11. The method of claim 10, wherein retrieving the aggregate data set is permitted with a corresponding access level.

12. A system comprising:
a central computer, the central computer comprising:
a database; and
a management software module; and
one or more user computers, communicatively coupled to the central computer, wherein the user computers are adapted to connect with the central computer, provide authorization information to the central computer to access one or more files in the database, wherein the files include one or more of an advertisement file, a scheduling file, or a rewards file, wherein the rewards file includes an indication of one or more unredeemed rewards of a radio station, and wherein the rewards are granted based on the amount of advertising or other services that the radio station provided to an advertiser.

13. The system of claim 12, further comprising a user interface to be displayed on the one or more computers, the user interface including a scheduling interface to display some or all of a schedule of advertisements, wherein the scheduling interface includes a graphical radio dial displaying one or more radio stations, wherein each radio station is associated with one or more advertisements on the schedule of advertisements.

14. A system comprising:
a plurality of radio stations;
a radio station cluster, wherein the radio station cluster includes one or more radio stations selected from the plurality of radio stations;
a central computer comprising:
a database to store advertising data, scheduling data, or rewards data associated with each of the plurality of radio stations;
a management software module to control access to the database;
a cluster manager computer, communicatively connected to the central computer, wherein the cluster manager computer is adapted to provide to a cluster manager an aggregate view of advertising data, scheduling data, or rewards data for the one or more radio stations in the radio station cluster; and
a plurality of station manager computers, each station manager computer communicatively coupled to one of the plurality of radio stations and adapted to provide a corresponding station manager a limited view of advertising data, scheduling data, or rewards data for the associated radio station.

15. The system of claim 14, wherein the cluster manager view and the station manager view are provided using a graphical user interface.

16. The system of claim 15, wherein the graphical user interface includes a radio dial, wherein the radio dial provides an indication of one or more radio stations associated with a current data view.
